(19) United States
(12) Patent Application Publication
(10) Pub. No.: US 2025/0256641 A1
(43) Pub. Date: Aug. 14, 2025

(54) Vehicle Braking Awareness System

(71) Applicant: Jason Heard, Sacramento, CA (US)

(72) Inventor: Jason Heard, Sacramento, CA (US)

(21) Appl. No.: 19/037,472

(22) Filed: Jan. 27, 2025

Related U.S. Application Data
(60) Provisional application No. 63/552,367, filed on Feb. 12, 2024.

(51) Int. Cl. B60Q 1/44; B60T 17/22

(52) U.S. Cl. CPC B60Q 1/444; B60T 17/22

(57) ABSTRACT

A vehicle braking awareness system is provided comprised of a brake signaling system designed to communicate a vehicle's braking intensity dynamically to following motorists, thereby enhancing road safety by reducing accident risks from sudden braking. The system comprises a pressure sensor assembly for detecting braking force, a microcontroller unit for processing real-time data and determining brake light patterns, a brake light assembly using high-lumen LEDs for varied light responses, and an adaptive light control module that adjusts brightness based on ambient lighting. The pressure sensor assembly includes a brake pedal and hydraulic sensors for precise force detection. The microcontroller unit ensures efficient processing with response times under 10 milliseconds. The brake light assembly produces pulsating or continuous light patterns based on braking intensity, activating LEDs within 1 to 5 milliseconds. The adaptive light control module modifies brightness between 500 and 2,000 lumens to optimize visibility.

### CROSS-REFERENCE TO RELATED APPLICATION

The present application claims priority to, and the benefit of, U.S. Provisional Application No. 63/552,367, which was filed on Feb. 12, 2024, and is incorporated herein by reference in its entirety.

### FIELD OF THE INVENTION

The present invention relates generally to the field of vehicle braking systems. More specifically, the present invention relates to a brake signaling system that dynamically communicates a vehicle's braking intensity to following motorists through a combination of pressure sensors, a microcontroller unit, adaptive brake light patterns, and optional alert systems, thereby enhancing road safety and reducing rear-end collisions. The system adjusts LED brightness based on ambient lighting and integrates with vehicle diagnostics to provide clearer and faster braking feedback. Accordingly, the present disclosure makes specific reference thereto. Nonetheless, it is to be appreciated that aspects of the present invention are also equally applicable to other like applications, devices, and methods of manufacture.

### BACKGROUND

In the context of road safety, one of the persistent challenges for motorists is accurately perceiving the braking intensity of vehicles ahead. A motorist may be unaware of how rapidly another vehicle is decelerating, which limits the time available to respond appropriately. This issue becomes particularly problematic in high-traffic areas, where sudden stops are frequent and response times are minimal. Misinterpretation of braking signals can lead to rear-end collisions, posing risks of significant property damage and personal injury. Traditional brake lights are designed to indicate that a vehicle is slowing down but do not communicate the degree of braking pressure applied. This limitation leaves drivers guessing how hard the vehicle ahead is braking, leading to delayed or inappropriate reactions. In emergency braking situations, this lack of clarity can mean the difference between avoiding an accident and causing a collision. Additionally, the uniform appearance of brake lights, regardless of the urgency of the stop, contributes to misunderstandings on the road. These misunderstandings can create dangerous situations, especially in poor weather conditions, low visibility, or when driving at high speeds. Without a system to clearly convey braking intensity, drivers are left to rely on intuition and judgment, which are often inadequate for preventing accidents caused by sudden or unexpected braking.

Therefore, there exists a long-felt need in the art for a vehicle braking awareness system that improves communication of braking intensity to surrounding motorists. There also exists a long-felt need in the art for a vehicle braking awareness system that differentiates between light and abrupt braking through distinct visual signals. Moreover, there exists a long-felt need in the art for a vehicle braking awareness system that provides an efficient mechanism to alert other drivers of a vehicle's immediate stopping intention, thereby reducing accident risks.

The subject matter disclosed and claimed herein, in one embodiment thereof, comprises a vehicle braking awareness system. The system is comprised of a brake signaling system designed to communicate a vehicle's braking intensity dynamically to following motorists, thereby enhancing road safety by reducing accident risks from sudden braking. The system comprises a pressure sensor assembly for detecting braking force, a microcontroller unit for processing real-time data and determining brake light patterns, a brake light assembly using high-lumen LEDs for varied light responses, and an adaptive light control module that adjusts brightness based on ambient lighting. The pressure sensor assembly includes a brake pedal and hydraulic sensors for precise force detection. The microcontroller unit ensures efficient processing with response times under 10 milliseconds and integrates with vehicle diagnostics via an OBD-II interface. The brake light assembly produces pulsating or continuous light patterns based on braking intensity, activating LEDs within 1 to 5 milliseconds. The adaptive light control module modifies brightness between 500 and 2,000 lumens to optimize visibility. Optional alert systems provide color-coded signals or activate hazard lights during abrupt braking. The system offers universal compatibility for various vehicle types and can be retrofitted to older models, improving communication of braking intent and reducing rear-end collisions.

In this manner, the vehicle braking awareness system of the present invention accomplishes all the foregoing objectives and provides a brake light system that varies based on braking intensity. When slight pressure is applied to the brake pedal, the system activates distinct flashes to signal mild deceleration to following drivers. If the driver applies full pressure to the brakes, the system switches to a solid light to indicate a complete or abrupt stop. These differentiated signals ensure that motorists can quickly interpret the braking status of vehicles ahead. By providing clear and timely braking information, the system enhances driver response times and significantly reduces the likelihood of collisions caused by abrupt or misinterpreted braking events. This innovative system ultimately contributes to safer roads by improving communication between vehicles and reducing uncertainties related to braking behavior.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle braking awareness system. The brake signaling system dynamically communicates a vehicle's braking intensity to following motorists, reducing the risk of accidents due to sudden braking. The system is comprised of a pressure sensor assembly, a microcontroller unit, a brake light assembly, an adaptive light control module, and optional alert systems.

The pressure sensor assembly detects braking force and can be integrated into locations such as the brake pedal or hydraulic brake lines. Configurations may include a brake pedal sensor using a force-sensitive resistor or strain gauge, and a hydraulic pressure sensor to capture fluid pressure changes. Combined sensors provide precise detection, with a range of 0.1 to 100 PSI.

The microcontroller unit processes data from the pressure sensor assembly and determines appropriate brake light patterns based on braking intensity. It comprises a low-power microcontroller, a signal processing module that categorizes braking levels, and a communication interface for vehicle diagnostics via an OBD-II interface. The unit offers response times under 10 milliseconds.

The brake light assembly uses high-lumen LED arrays to display varied light patterns. Light braking generates rapid pulsating flashes, moderate braking displays pulsating flashes followed by steady light, and full braking shows a continuous solid light. The LED array activates within 1 to 5 milliseconds.

The adaptive light control module adjusts brake light brightness based on ambient lighting. An ambient light sensor increases brightness to 1,500-2,000 lumens during the day and reduces it to 500-800 lumens at night.

Optional alert systems include a color-coded warning system with an amber LED for initial deceleration and a red LED for a complete stop. A hazard light activation module can engage hazard lights during sudden braking.

Accordingly, the vehicle braking awareness system of the present invention is particularly advantageous as it provides a brake light system that varies based on braking intensity. When slight pressure is applied to the brake pedal, the system activates distinct flashes to signal mild deceleration to following drivers. If the driver applies full pressure to the brakes, the system switches to a solid light to indicate a complete or abrupt stop. These differentiated signals ensure that motorists can quickly interpret the braking status of vehicles ahead. By providing clear and timely braking information, the system enhances driver response times and significantly reduces the likelihood of collisions caused by abrupt or misinterpreted braking events. This innovative system ultimately contributes to safer roads by improving communication between vehicles and reducing uncertainties related to braking behavior. In this manner, the vehicle braking awareness system overcomes the limitations of existing vehicle brake light systems known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle braking awareness system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a vehicle braking awareness system that improves communication of braking intensity to surrounding motorists. There also exists a long-felt need in the art for a vehicle braking awareness system that differentiates between light and abrupt braking through distinct visual signals. Moreover, there exists a long-felt need in the art for a vehicle braking awareness system that provides an efficient mechanism to alert other drivers of a vehicle's immediate stopping intention, thereby reducing accident risks.

The present invention, in one exemplary embodiment, is comprised of a vehicle braking awareness system. The brake signaling system effectively communicates a vehicle's braking intensity to following motorists, helping reduce the risk of accidents caused by sudden braking. The system comprises a pressure sensor assembly, a microcontroller unit, a brake light assembly, an adaptive light control module, and optional alert systems.

The pressure sensor assembly measures braking force and can be installed in locations such as the brake pedal or hydraulic brake lines. Configurations may include a brake pedal sensor using a force-sensitive resistor or strain gauge and a hydraulic pressure sensor for detecting fluid pressure changes. The combination of these sensors enables accurate detection within a range of 0.1 to 100 PSI.

The microcontroller unit processes data from the pressure sensor assembly and determines the appropriate brake light pattern based on braking intensity. It includes a low-power microcontroller, a signal processing module to categorize braking levels, and a communication interface for transmitting data to vehicle diagnostics through an OBD-II interface. The unit provides response times of under 10 milliseconds.

The brake light assembly utilizes high-lumen LED arrays to produce various light patterns. Light braking triggers rapid pulsating flashes, moderate braking initiates pulsating flashes followed by a steady light, and full braking results in a continuous solid light. The LED array activates within 1 to 5 milliseconds.

The adaptive light control module adjusts the brightness of the brake lights according to ambient lighting conditions. An ambient light sensor increases brightness to 1,500-2,000 lumens during daylight and decreases it to 500-800 lumens at night to minimize glare.

Optional alert systems include a color-coded warning system with an amber LED for initial deceleration and a red LED for a full stop. A hazard light activation module can automatically engage hazard lights during sudden braking.

The vehicle braking awareness system offers significant advantages by providing a brake light system that adjusts based on braking intensity. For light braking, distinct flashes signal mild deceleration to following drivers. For full braking, a solid light indicates an abrupt stop. These differentiated signals enable motorists to quickly interpret the braking status of vehicles ahead. By delivering clear and timely braking information, the system enhances driver reaction times and reduces the risk of collisions caused by sudden or unclear braking. This innovation improves road safety by enhancing vehicle-to-vehicle communication and addressing the limitations of existing brake light systems.

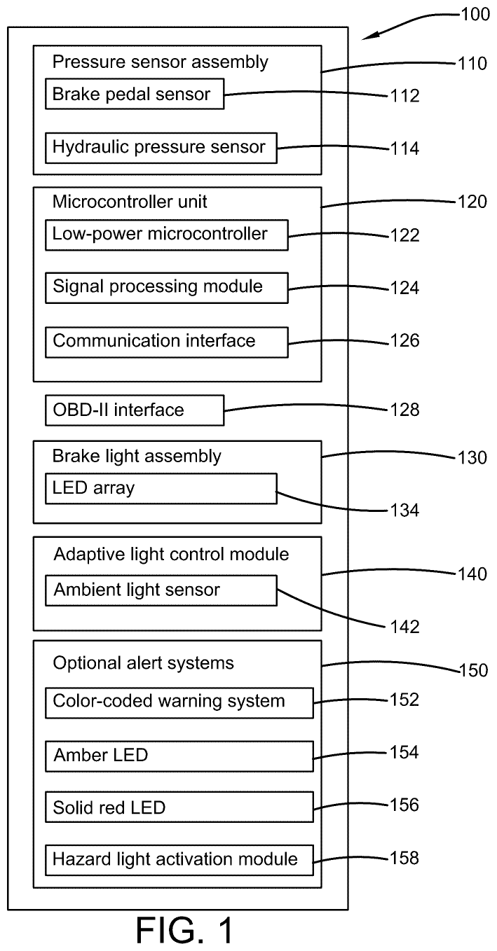

Referring initially to the drawings, FIG. 1 illustrates a perspective view of one potential embodiment of a vehicle braking awareness system 100 of the present invention in accordance with the disclosed architecture. The system 100 is a brake signaling solution designed to dynamically communicate a vehicle's braking intensity to following motorists. By providing clearer feedback regarding braking behavior, the system 100 reduces the risk of accidents caused by sudden or unexpected braking. The system 100 comprises at least one pressure sensor assembly 110, at least one microcontroller unit 120, at least one brake light assembly 130, at least one adaptive light control module 140, and a plurality of optional alert systems 150.

A pressure sensor assembly 110 detects the degree of force applied to the braking system of a vehicle 10 and can be integrated into various locations 12 on the vehicle 10, such as, but not limited to, the brake pedal or the hydraulic brake lines. In one configuration, the assembly 110 is comprised of a brake pedal sensor 112 that uses a force-sensitive resistor or strain gauge to measure applied foot pressure. A hydraulic pressure sensor 114 may be additionally or alternatively used to capture fluid pressure changes within the braking system. For enhanced accuracy, one embodiment of the assembly 110 may combine both types of sensors 112, 114, allowing for more precise detection of braking force. The pressure sensor assembly 110 is preferably capable of detecting subtle variations, with a detection range extending from 0.1 to 100 pounds per square inch (PSI).

A microcontroller unit 120 processes real-time data received from a pressure sensor assembly 110 and determines the appropriate brake light pattern based on the detected braking intensity of the vehicle 10. The microcontroller unit 120 comprises a low-power microcontroller 122 that ensures efficient energy use while maintaining near-instantaneous response times of less than 10 milliseconds. A signal processing module 124 within the microcontroller unit 120 analyzes the pressure data and categorizes braking intensity into predefined levels, such as, but not limited to, light, moderate, or full braking. To enable integration with modern vehicle systems, a communication interface 126 can transmit data to vehicle diagnostics through an OBD-II interface 128.

A brake light assembly 130 preferably employs high-lumen LED arrays capable of producing varied light patterns and intensities based on braking force. For light braking, characterized by slight pressure, the system 100 generates a pulsating red light pattern comprising of a plurality of rapid flashes at intervals of approximately, but not limited to, 100 milliseconds. For moderate braking, indicative of significant deceleration, the assembly 130 activates a sequence of a plurality of pulsating flashes followed by a steady red light. In cases of full or emergency braking, which signifies an urgent stop, the brake light assembly 130 illuminates as a continuous solid light. An LED array 134 activates within 1 to 5 milliseconds, ensuring rapid illumination for immediate feedback to following drivers.

To optimize visibility, an adaptive light control module 140 adjusts the brightness of a brake light assembly 130 based on ambient lighting conditions. The adaptive light control module 140 includes an ambient light sensor 142 that detects external light levels, enabling the system 100 to increase LED brightness during daytime, preferably to levels between 1,500 and 2,000 lumens, and reduce brightness at night to minimize glare, preferably to levels between 500 and 800 lumens.

The system 100 also includes optional alert systems 150 to further enhance safety and driver awareness, as shown in FIG. 1. More specifically, a color-coded warning system 152 can incorporate an amber LED 154 to signal initial deceleration and a solid red LED 156 to indicate a complete stop, offering a nuanced communication method to following motorists. Additionally, the system 100 can automatically engage the vehicle's 10 hazard lights through a hazard light activation module 158 during sudden or forceful braking, providing an extra layer of warning to surrounding drivers.

The system 100 is designed for universal compatibility, making it suitable for various vehicle types, including sedans, trucks, electric vehicles, etc. The system 100 can be retrofitted to older vehicles and integrated into modern vehicles through an OBD-II port 128.

By dynamically communicating braking intent and intensity, the system 100 addresses the critical issue of unclear braking signals, helping drivers react faster to sudden deceleration and thereby reducing the likelihood of rear-end collisions and improving overall road communication.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle braking awareness system” and “system” are interchangeable and refer to the vehicle braking awareness system 100 of the present invention.

Notwithstanding the foregoing, the vehicle braking awareness system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle braking awareness system 100 as shown in the FIGS. are for illustrative purposes only, and that many other sizes and shapes of the vehicle braking awareness system 100 are well within the scope of the present disclosure. Although the dimensions of the vehicle braking awareness system 100 are important design parameters for user convenience, the vehicle braking awareness system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle braking awareness system comprising:
a pressure sensor assembly configured to detect a degree of force applied to a braking system of a vehicle;
a microcontroller unit configured to process a real-time data received from the pressure sensor assembly and to determine a brake light pattern based on a braking intensity;
a brake light assembly configured to produce a light pattern and an intensity in response to the brake light pattern determined by the microcontroller unit; and
an adaptive light control module configured to adjust a brightness of the brake light assembly based on an ambient lighting condition.

2. The vehicle braking awareness system of claim 1, wherein the pressure sensor assembly is comprised of a brake pedal sensor configured to measure an applied foot pressure.

3. The vehicle braking awareness system of claim 2, wherein the pressure sensor assembly is comprised of a force-sensitive resistor.

4. The vehicle braking awareness system of claim 2, wherein the pressure sensor assembly is comprised of a strain gauge.

5. The vehicle braking awareness system of claim 1, wherein the pressure sensor assembly comprises a hydraulic pressure sensor configured to measure a fluid pressure change within the braking system.

6. The vehicle braking awareness system of claim 1, wherein the pressure sensor assembly is configured to detect a braking force within a range of 0.1 to 100 pounds per square inch.

7. The vehicle braking awareness system of claim 1, wherein the microcontroller unit comprises a signal processing module configured to categorize a braking intensity into a predefined level.

8. The vehicle braking awareness system of claim 7, wherein the brake light assembly is configured to produce a pulsating light pattern.

9. The vehicle braking awareness system of claim 7, wherein the light assembly is configured to produce a sequence of pulsating flashes followed by a steady light for a moderate braking.

10. The vehicle braking awareness system of claim 7, wherein the brake light assembly is configured to produce a continuous solid light for a full or an emergency braking.

11. A vehicle braking awareness system comprising:
a pressure sensor assembly configured to detect a degree of braking force;
a microcontroller unit comprising a signal processing module configured to categorize the braking force into a predefined level; and
a brake light assembly configured to produce a plurality of varying light patterns corresponding to the predefined level.

12. The vehicle braking awareness system of claim 11, wherein the microcontroller unit comprises a communication interface configured to integrate with a vehicle diagnostic through an OBD-II interface.

13. The vehicle braking awareness system of claim 11, wherein the predefined level is comprised of a light braking, a moderate braking, or a full braking.

14. The vehicle braking awareness system of claim 13, wherein the brake light assembly comprises an LED array configured to produce a pulsating light for the light braking.

15. The vehicle braking awareness system of claim 13, wherein the brake light assembly is configured to produce a steady light for the moderate braking.

16. The vehicle braking awareness system of claim 13, wherein the brake light assembly is configured to produce a continuous solid light for the full braking.

17. A vehicle braking awareness system comprising:
a pressure sensor assembly configured to detect a degree of force applied to a braking system of a vehicle, the pressure sensor assembly comprising a brake pedal sensor and a hydraulic pressure sensor;
a microcontroller unit configured to receive a real-time data from the pressure sensor assembly and to determine a brake light pattern based on a braking intensity, the microcontroller unit further comprising a signal processing module configured to categorize the braking intensity into a predefined level;
a brake light assembly comprising an LED array configured to produce a varying light pattern and a varying intensity based on the brake light pattern determined by the microcontroller unit; and
an adaptive light control module configured to adjust a brightness of the brake light assembly based on an ambient lighting conditions, wherein the adaptive light control module comprises an ambient light sensor configured to detect an external light level.

18. The vehicle braking awareness system of claim 17, wherein the pressure sensor assembly is configured to detect braking force within a range of 0.1 to 100 pounds per square inch.

19. The vehicle braking awareness system of claim 17, wherein the microcontroller unit is further comprised of a communication interface.

20. The vehicle braking awareness system of claim 19, wherein the communication interface is configured to transmit data to a vehicle diagnostic through an OBD-II interface.
